(19) United States
(12) Patent Application Publication
(10) Pub. No.: US 2016/0188111 A1
(43) Pub. Date: Jun. 30, 2016

(54) OPTICAL TOUCH APPARATUS AND TOUCH SENSING METHOD THEREOF

(71) Applicant: Coretronic Corporation, Hsin-Chu (TW)

(72) Inventors: Je-Fu Cheng, Hsin-Chu (TW); Hao-Feng Hung, Hsin-Chu (TW)

(21) Appl. No.: 14/806,683

(22) Filed: Jul. 23, 2015

(30) Foreign Application Priority Data
Dec. 31, 2014 (CN) 201410849673.4

(51) Int. Cl. G06F 3/041; G06F 3/042

(52) U.S. Cl. CPC G06F 3/0418; G06F 3/0421

(57) ABSTRACT

The invention provides an optical touch apparatus including a light curtain generator, a light detection apparatus, and an operation unit, and a touch sensing method thereof. In a predetermined period where no touch object is on the detection surface, the operation unit controls the light curtain generator to generate a light curtain and obtains a first image by using the light detection apparatus, analyzes the first image to obtain an interference signal, and sets an area where the interference signal is located on the detection surface as an interference area. During a touch operation period, the operation unit obtains a second image, analyzes and determines whether a touch object of a touch signal in the second image is located in the interference area, and calculates a respective touch coordinate of the touch object corresponding to the touch signal based on the touch signal not located in the interference area.

### CROSS-REFERENCE TO RELATED APPLICATION

This application claims the priority benefit of China application serial no. 201410849673.4, filed on Dec. 31, 2014. The entirety of the above-mentioned patent application is hereby incorporated by reference herein and made a part of this specification.

### BACKGROUND OF THE INVENTION

1. Field of the Invention

The invention relates to a touch sensing technology of an electronic equipment, and particularly relates to an optical touch apparatus and a touch sensing method thereof.

2. Description of Related Art

In recent years, electronic products with touch input interfaces, such as electronic products with touch screens, are very popular and have gradually become mainstream on the market due to being convenient and intuitive to operate. Among the touch technologies applicable to electronic equipments, capacitive touch screens offer good touch effects. However, because of high cost and limited range of the screen, the application of capacitive touch screens is limited. As for other touch technologies, there is an optical touch technology using an optical touch module to detect a touch position. Because of its advantages such as low cost and high accuracy, etc., it is advantageous in the competitive market and has become another option for large-sized touch screens.

Conventional optical touch apparatuses use an infrared laser emitter to generate a laser light curtain on a detection surface. Whenever there is a touch object (e.g., light pen, finger, etc.,) performing a touch operation (e.g., clicking, dragging, etc.,) on the detection surface, the touch object in the laser curtain may reflect the laser to generate a touch signal (e.g., a light spot). An image including the touch signal may be captured by using an image capturing apparatus such as a camera, so as to calculate a coordinate of the touch object on the detection surface, thereby positioning the touch coordinate. Patent documents related to the optical touch technology include China Patent Application Publication No. 10161727A, China Patent Application Publication No. 102999234A, and China Patent Application Publication No. 103092439A.

However, if some areas in the detection surface of the optical touch apparatus are protuberant due to unevenness on the detection surface, the protuberant interfering objects may result in unexpected reflection of laser light, leading to an unexpected touch signal that results in a touch sensing misjudgment.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides an optical touch apparatus and a touch sensing method thereof. The optical touch apparatus may eliminate an influence of an interfering object on a detection surface to prevent a touch sensing misjudgment.

Other objects and advantages of the invention can be further illustrated by the technical features broadly embodied and described as follows.

In order to achieve one or a portion of or all of the objects or other objects, an embodiment of the invention provides an optical touch apparatus including a light curtain generator, a light detection apparatus, and a operation unit. The light curtain generator is adapted to provide a light curtain on a detection surface and parallel to the detection surface.

The light detection apparatus is adapted to capture an image corresponding to the light curtain on the detection surface. In a predetermined period where no touch object is on the detection surface, the operation unit is adapted to control the light curtain generator to generate the light curtain and obtain a first image by using the light detection apparatus, analyze the first image to obtain an interference signal of an interfering object on the detection surface, and set an area where the interfering object corresponding to the interference signal is located on the detection surface as an interference area. During a touch operation period, the operation unit is adapted to control the light curtain generator to generate the light curtain, obtain a second image by using the light detection apparatus, analyze and determine whether a touch object corresponding to a touch signal in the second image is located in the interference area, and calculate a respective touch coordinate of a touch position of the touch object corresponding to the touch signal based on the touch signal of the touch object not located in the interference area.

According to an embodiment of the invention, the detection surface includes an operation surface. The operation unit is adapted to calculate the touch coordinate of the touch position of the touch object corresponding to the touch signal based on the touch signal of the touch object not located in the interference area and located in the operation surface.

According to an embodiment of the invention, the light curtain generator is an infrared light curtain generator, and the light curtain is an infrared light curtain. The light detection apparatus is adapted to capture an image corresponding to the infrared light curtain on the detection surface.

According to an embodiment of the invention, the interference signal is generated by the interfering object on the detection surface passing through the light curtain.

According to an embodiment of the invention, the optical touch apparatus further includes a projection apparatus. The projection apparatus project an image onto at least a partial area of the detection surface.

In order to achieve one or a portion of or all of the objects or other objects, an embodiment of the invention provides a touch sensing method for an optical touch apparatus. The optical touch apparatus includes a light curtain generator and a light detection apparatus. The light curtain generator is adapted to provide a light curtain. The light detection apparatus is adapted to capture an image corresponding to the light curtain on the detection surface. According to the touch sensing method, in a predetermined period where no touch object is on the detection surface, the light curtain is generated by using the light curtain generator and a first image is obtained by using the light detection apparatus. The first image is analyzed to obtain an interference signal corresponding to an interfering object on the detection surface. An area where the interfering object corresponding to the interference signal is located on the detection surface is set as an interference area. During a touch operation period, the light curtain is generated by using the light curtain generator and a second image is obtained by using the light detection apparatus. Whether a touch object corresponding to a touch signal in the second image is in the interference area is analyzed and detell ained. A respective touch coordinate of a touch position of the touch object corresponding to the touch signal is calculated based on the touch signal of the touch object not located in the interference area.

According to an embodiment of the invention, the detection surface includes an operation surface. Also, calculating the respective touch coordinate of the touch position of the touch object corresponding to the touch signal includes calculating the touch coordinate of the touch position of the touch object corresponding to the touch signal based on the touch signal not located in the interference area and located in the operation surface.

The optical touch apparatus according to the embodiments of the invention may identify the interference area where the interfering object is on the detection surface in advance before starting performing the touch operation. When the touch operation is performed, the detection on the interference area is eliminated and the touch coordinate is correctly calculated, so as to eliminate an influence of the interfering object and prevent a touch sensing misjudgment.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic block diagram illustrating an optical touch apparatus according to an embodiment of the invention.

FIG. 2 is a flowchart illustrating a touch sensing method of an optical touch apparatus according to an embodiment of the invention.

FIGS. 3A to 3C are diagrams illustrating examples of a touch sensing method of an optical touch apparatus according to an embodiment of the invention.

FIG. 4 is a flowchart illustrating a touch sensing method of an optical touch apparatus according to an embodiment of the invention.

FIG. 5 is a diagram illustrating an example of a touch sensing method of an optical touch apparatus according to an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention.

Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that

“A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

To identify a touch coordinate of a touch operation, embodiments of the invention provide an optical touch apparatus. The optical touch apparatus is capable of analyzing an interference area where a touch sensing misjudgment may possibly be rendered due to a bump, for example, on a detection surface before receiving a touch operation, so as to eliminate an influence of an interfering object during touch sensing, thereby obtaining a correct touch coordinate.

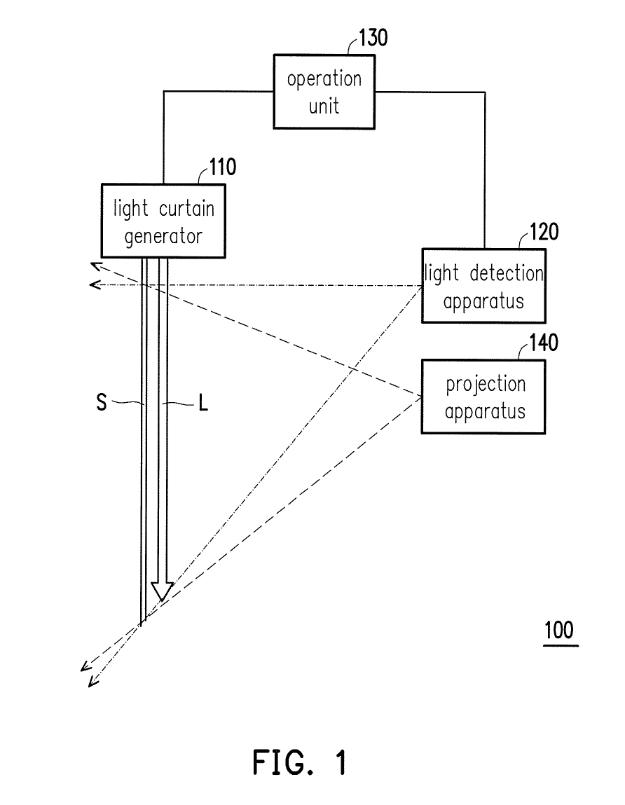

FIG. 1 is a schematic block diagram illustrating an optical touch apparatus 100 according to an embodiment of the invention. Referring to FIG. 1, in this embodiment, the optical touch apparatus 100 includes a light curtain generator 110, a light detection apparatus 120, and an operation unit 130. The light curtain generator 110 is an infrared light curtain generator, for example. In FIG. 1, the light curtain generator 110 may provide a light curtain L on a detection surface S. The light curtain L may be an infrared light curtain, for example, and parallel to the detection surface S.

The light detection apparatus 120 may be any kind of elements/circuits for sensing an infrared light image. For example, the light detection apparatus 120 may be a complementary metal oxide semiconductor (CMOS) or a charge-coupled device CCD.

However, the invention is not limited thereto. In FIG. 1, the light detection apparatus 120 may capture an image corresponding to the light curtain L on the detection surface S.

The operation unit 130 may be a single-core or multi-core central processing unit (CPU) or other programmable general purpose or specific purpose microprocessor, digital signal processor (DSP), ASIC, or programmable controller, etc., for example. The operation unit 130 is coupled to the light curtain generator 110 and the light detection apparatus 120, so as to realize a touch sensing function, such as determining the position of the touch point by using the triangulation algorithm.

The optical touch apparatus 100 may also include a projection apparatus 140. The projection apparatus 140, such as a projector, may project an image to a partial or complete area of the detection surface S, so as to allow the user to perform a touch operation on the light curtain L based on information displayed in the image. It should be noted that even though the light detection apparatus 120 and the operation unit 130 are exemplified as separate and independent components in this embodiment, the invention is not limited thereto. In other embodiments, the operation unit 130 and the light detection apparatus 120 may be integrated into one apparatus, or the light detection apparatus 120 and the operation unit 130 may be integrated in the projection apparatus 140. In the following, an embodiment is provided to describe steps regarding how touch sensing is performed by the optical touch apparatus 100.

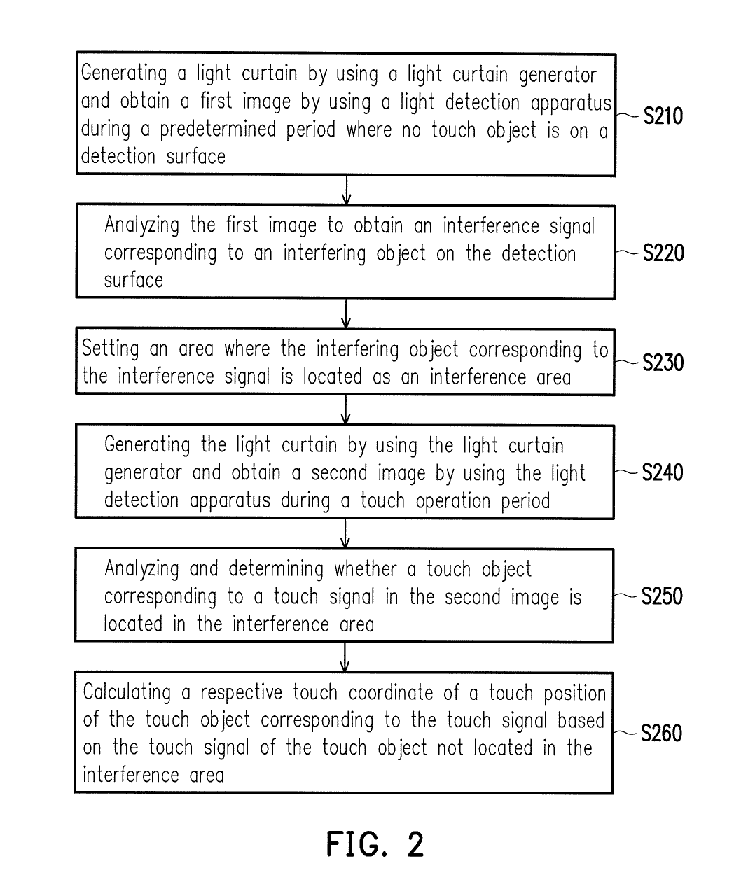

FIG. 2 is a flowchart illustrating a touch sensing method of an optical touch apparatus according to an embodiment of the invention. Referring to FIGS. 1 and 2 together, the touch sensing method of this embodiment is applicable to the optical touch apparatus 100 in FIG. 1. In the following, respective steps of the touch sensing method of embodiments of the invention are described with reference to the optical touch apparatus 100.

At Step S210, when the optical touch apparatus 100 is turned on, namely during a predetermined period (e.g. the preliminary period) where no touch object is on the detection surface S, the operation unit 130 may generate the light curtain L on the detection surface S by using the light curtain generator 110 and obtain a detection image by using the light detection apparatus 120. The operation unit 130 may firstly determine whether the optical touch apparatus 100 enters the predetermined period. The predetermined period refers to a state where the optical touch apparatus 100 does not receive any touch operation. Thus, there is no user's touch object (e.g., light pen, finger, etc.) on the detection surface S in the predetermined period. As shown in FIG. 1, when the optical touch apparatus 100 is in the predetermined period, the operation unit 130 may control the light curtain generator 110 to generate the light curtain L. The light curtain L is emitted in parallel to the detection surface S. The operation unit 130 may capture an image on the detection surface S by using the light detection apparatus 120, so as to obtain the detection image without any touch object (i.e., first image).

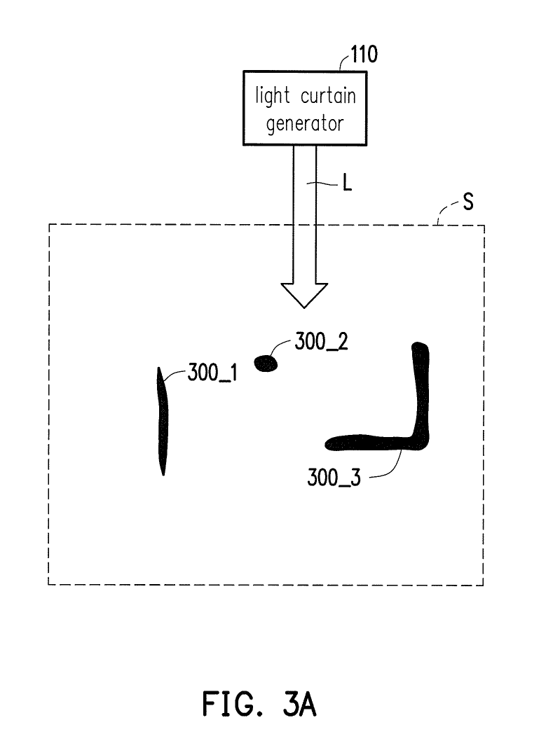

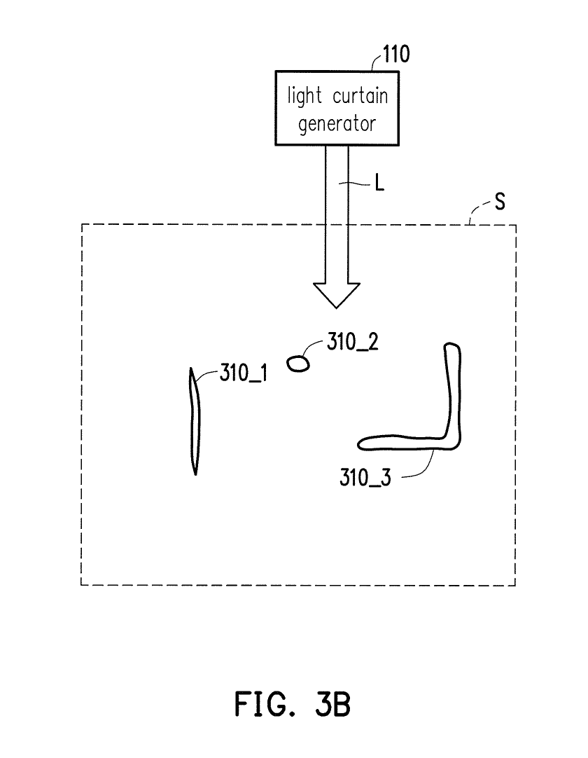

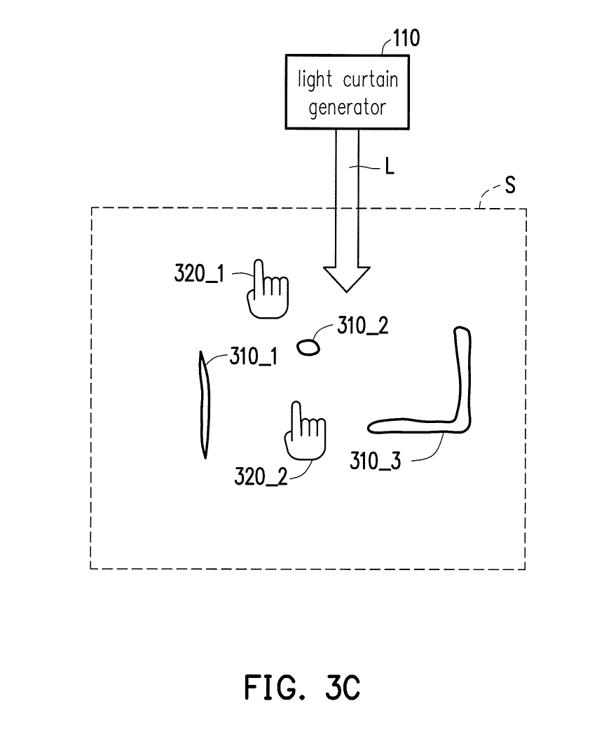

At Step S220, the operation unit 130 may analyze the image to obtain an interference signal of the detection surface S. For example, FIGS. 3A to 3C are diagrams illustrating examples of a touch sensing method of an optical touch apparatus according to an embodiment of the invention. In FIG. 3A, it is assumed that there are interfering objects (e.g., interfering objects 300_1 to 300_3), such as reflective strips or bumps on the detection surface S. The interfering objects may influence a judgment of touch sensing. The light curtain L emitted by the light curtain generator 110 may be reflected when the interfering objects 300_1 to 300_3 block a path of the light curtain L, and interference signals corresponding to the reflected light may be generated in the detection image captured by the light detection apparatus 120. The interference signal is, for example, a light spot, or an image or information represents a position where an interfering object is located. Thus, the operation unit 130 may analyze the detection image and obtain the interference signals and the locations of the interfering objects corresponding to the interference signals on the detection surface S. At Step S230, the operation unit 130 may set areas where the interfering objects corresponding to the interference signals are located as interference areas (e.g., interference areas 310_1 to 310_3 shown in FIG. 3B).

At Step S240, during a touch operation period, the operation unit 130 may generate the light curtain L by using the light curtain generator 110. The operation unit 130 may obtain a touch image (i.e., second image) by using the light detection apparatus 120. The operation unit 130 may firstly determine whether the optical touch apparatus 100 enters the touch operation period. The touch operation period refers to a state where the optical touch apparatus 100 starts receiving the user's touch operation. During the touch operation, the user may touch the detection surface S with a touch object, such as a light pen or the user's finger, to perform touch operations such as clicking or dragging. As shown in FIG. 1, when the optical touch apparatus 100 is in the touch operation, the operation unit 130 may control the light curtain generator 110 to generate the light curtain L on the detection surface S. When the user performs the touch operation to the optical touch apparatus 100, the operation unit 130 may capture an image by using the light detection apparatus 120 facing the detection surface S to obtain the touch image including the touch object.

At Step 250, the operation unit 130 may analyze and determine whether a touch object corresponding to a touch signal in the touch image is located in the interference areas 310_1 to 310_3 of the detection surface S. The touch signal is, for example, a light spot, or an image or infoimation represents apposition where an interfering object is located. For example, in FIG. 3C, it is assumed that the user touches the detection surface S with two fingers as touch objects, and light is reflected because the touch objects block the path of the light curtain L, such that corresponding touch signals (e.g., touch signals 320_1 and 320_2) are generated in the touch image captured by the light detection apparatus 120. It should be noted that numerals 320_1 and 320_2 labeled on the fingers (touch objects) indicated in FIG. 3 is used to illustrate that the touch signals 320_1 and 320_2 are from the corresponding fingers (touch objects). The operation unit 130 may compare the detection image previously captured and the touch image to identify the touch signals 320_1 and 320_2, and determine whether touch objects represented by the touch signals 320_1 and 320_2 are located in the interference areas 310_1 to 310_3.

At Step S260, the operation unit 130 may calculate respective touch coordinates of touch positions of the touch objects corresponding to the touch signals 320_1 and 320_2 based on the touch signals 320_1 and 320_2 that the corresponding touch objects (which may be represented by the touch signals 320_1 and 320_2) are not located in the interference areas 310_1 to 310_3. If a touch object (which may be represented by the touch signal) is located in any of the interference areas 310_1 to 310_3, the operation unit 130 does not perform calculation of touch coordinate of the touch position of such touch object. The operation unit 130 may eliminate influences from the interference areas 310_1 to 3103, calculate the respective touch coordinates of the touch signals 320_1 and 320_2 only based on the touch signals 320_1 and 320_2 of touch objects not located in the interference areas 310_1 to 310_3, and correctly identify the user's touch positions on the detection surface S by using the triangulation method, for example. Therefore, after the optical touch apparatus 100 is turned on, the operation unit 130 calculates the interference areas 310_1 to 310_3 by using the detection image captured by the light detection apparatus 120. In the subsequent touch operation, the operation unit 130 compares the detection image firstly captured with the touch image to determine whether touch objects represented by the touch signals 320_1 and 320_2 are in the interference areas 310_1 to 310_3. It should be noted that while this embodiment of the invention is described by using two touch signals 320_1 and 320_2 and three interfering objects 300_1 to 300_3 as an example, the invention does not intend to limit the number of touch objects, interfering objects, and touch signals.

In an embodiment, the operation unit 130 may perform judgment on an operation surface (operation area) that actually receives the touch operation on the detection surface of the optical touch apparatus, and narrow down a detection range for sensing the touch operation on the operation surface. In this way, an efficiency of touch sensing is improved.

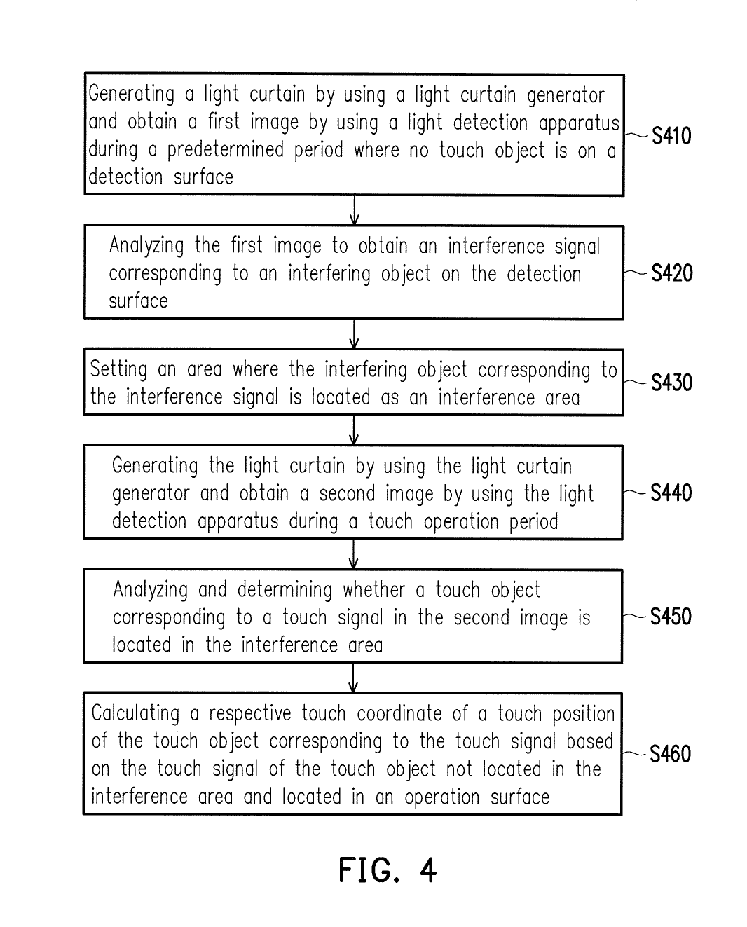

FIG. 4 is a flowchart illustrating a touch sensing method of an optical touch apparatus according to an embodiment of the invention. Referring to FIGS. 1 and 4, the touch sensing method of this embodiment is applicable to the optical touch apparatus 100 shown in FIG. 1. In the following, the respective steps of the touch sensing method of the optical touch apparatus of the invention are described with reference to the components of the optical touch apparatus 100.

At Step S410, during the predetermined period where no touch object is on the detection surface S, the operation unit 130 may generate the light curtain L on the detection surface S by using the light curtain generator 110 and obtain the detection image by using the light detection apparatus 120. At Step S420, the operation unit 130 may analyze the detection image to obtain the interference signal and the location of the interfering object corresponding to the interference signal on the detection surface S. At Step S430, the operation unit 130 may set the area where the interfering object corresponding to the interference signal is located as the interference area. At Step S440, during the touch operation period, the operation unit 130 may generate the light curtain L by using the light curtain generator 110 and obtain the touch image by using the light detection apparatus 120. At Step S450, the operation unit 130 may analyze and determine whether a touch object corresponding to the touch signal in the touch image is located in the interference area. Steps S410 to S450 are similar to or the same as Steps S210 to S250 in the previous embodiment. Thus, details thereof are not further reiterated below.

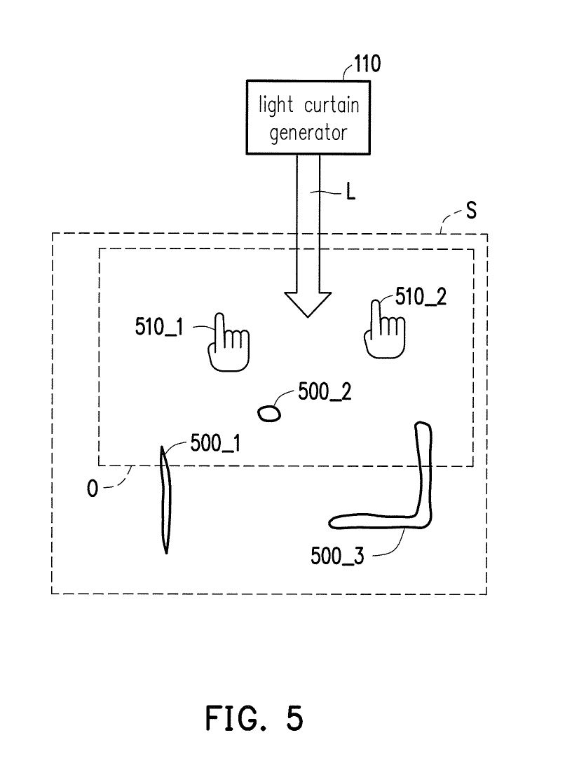

What differs from the embodiment in FIG. 2 is that, in this embodiment, the operation unit 130 may calculate the touch coordinate of touch position of the touch object corresponding to the touch signal based on the touch signal of the touch object not in the interference area and located in the operation surface at Step S460. For example, FIG. 5 is a diagram illustrating an example of a touch sensing method of an optical touch apparatus according to an embodiment of the invention. In FIGS. 1 and 5, the operation unit 130 may determine a range of an operation surface O that actually receives the user's touch operation on the detection surface, and the range of the operation surface O may cover a part of the detection surface S. The range of the operation surface O may be preset at the beginning of operating the optical touch apparatus 100 by selecting an area to be operated. The operation unit 130 may calculate touch coordinates of touch positions of touch objects corresponding to touch signals 510_1 and 510_2 on the operation surface O based on the touch signals (e.g., touch signals 510_1 and 510_2) of touch objects not located in the interference areas (e.g., interference areas 500_1 to 500_3) and located in the operation surface O by using triangulation, for example, so as to exclude detection to the interference areas 500_1 to 500_3 and correctly identify the user's touch positions. While this embodiment of the invention is described by using two touch signals 510_1 and 510_2 as an example, the invention does not intend to limit the number of touch objects and touch signals. It should be noted that numerals 510_1 and 510_2 labeled on the fingers (touch objects) indicated in FIG. 5 is used to illustrate that the touch signals 510_1 and 510_2 are from the corresponding touch objects.

The optical touch apparatus according to the embodiments of the invention is capable of capturing the image without the touch object (e.g., light pen, finger, etc.,) before the touch operation starts and when the light curtain is generated. The interference area that may interfere with touch sensing when the light curtain is actually emitted for detection is identified in advance based on the image. When the touch operation is performed, the touch sensing apparatus is capable of eliminating the detection on the interference area and correctly calculates the touch coordinate, so as to prevent the touch sensing misjudgment.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical touch apparatus, comprising:
a light curtain generator, adapted to provide a light curtain on a detection surface, wherein the light curtain is parallel to the detection surface;
a light detection apparatus, adapted to capture an image corresponding to the light curtain on the detection surface; and
an operation unit, coupled to the light detection apparatus and the light curtain generator,
wherein, in a predetermined period where no touch object is on the detection surface, the operation unit is adapted to control the light curtain generator to generate the light curtain and obtain a first image by using the light detection apparatus, analyze the first image to obtain an interference signal of an interfering object on the detection surface, and set an area where the interfering object corresponding to the interference signal is located on the detection surface as an interference area, and
wherein, during a touch operation period, the operation unit is adapted to control the light curtain generator to generate the light curtain, obtain a second image by using the light detection apparatus, analyze and determine whether a touch object corresponding to a touch signal in the second image is located in the interference area, and calculate a respective touch coordinate of a touch position of the touch object corresponding to the touch signal based on the touch signal of the touch object not located in the interference area.

2. The optical touch apparatus as claimed in claim 1, wherein the detection surface comprises an operation surface, and the operation unit is adapted to calculate the touch coordinate of the touch position of the touch object corresponding to the touch signal based on the touch signal of the touch object not located in the interference area and located in the operation surface.

3. The optical touch apparatus as claimed in claim 1, wherein the light curtain generator is an infrared light curtain generator, the light curtain is an infrared light curtain, and the light detection apparatus is adapted to capture an image corresponding to the infrared light curtain on the detection surface.

4. The optical touch apparatus as claimed in claim 1, wherein the interference signal is generated by the interfering object on the detection surface passing through the light curtain.

5. The optical touch apparatus as claimed in claim 1, further comprising:
a projection apparatus, adapted to project an image onto at least a partial area of the detection surface.

6. A touch sensing method for an optical touch apparatus, wherein the optical touch apparatus comprises a light curtain generator and a light detection apparatus, the light curtain generator is adapted to provide a light curtain on a detection surface, and the light detection apparatus is adapted to capture an image corresponding to the light curtain on the detection surface, the touch sensing method comprising:
in a predetermined period where no touch object is on the detection surface, generating the light curtain by using the light curtain generator and obtaining a first image by using the light detection apparatus;
analyzing the first image to obtain an interference signal corresponding to an interfering object on the detection surface;
setting an area where the interfering object corresponding to the interference signal is located on the detection surface as an interference area;
during a touch operation period, generating the light curtain by using the light curtain generator and obtaining a second image by using the light detection apparatus;
analyzing and determining whether a touch object corresponding to a touch signal in the second image is in the interference area; and
calculating a respective touch coordinate of a touch position of the touch object corresponding to the touch signal based on the touch signal of the touch object not located in the interference area.

7. The touch sensing method as claimed in claim 6, wherein the detection surface comprises an operation surface, the step of calculating the respective touch coordinate of the touch position of the touch object corresponding to the touch signal comprising:
calculating the touch coordinate of the touch position of the touch object corresponding to the touch signal based on the touch signal of the touch object not located in the interference area and located in the operation surface.

8. The touch sensing method as claimed in claim 6, wherein the light curtain generator is an infrared light curtain generator, the light curtain is an infrared light curtain, and the light detection apparatus is adapted to capture an image corresponding to the infrared light curtain on the detection surface.

9. The touch sensing method as claimed in claim 6, wherein the interference signal is generated by the interfering object on the detection surface passing through the light curtain.

10. The touch sensing method as claimed in claim 6, wherein the optical touch apparatus further comprises:
a projection apparatus, adapted to project an image onto at least a partial area of the detection surface.
